(19) United States
(12) Patent Application Publication
(10) Pub. No.: US 2008/0101515 A1
(43) Pub. Date: May 1, 2008

(54) Device And Method For Detecting Symbol Timing For Highly Bandwidth Efficient High Order Modulation System

(75) Inventor: Sung-Moon Yang, Kyeonggi-do (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: POSTDATA CO., LTD., KYEONGGI-DO (KR)

(21) Appl. No.: 11/813,493

(22) PCT Filed: Jan. 6, 2006
(86) PCT No.: PCT/KR06/00057

§ 371 Date: Jul. 6, 2007

(30) Foreign Application Priority Data
Jan. 7, 2005 (KR) 10-2005-0001837

(51) Int. Cl. H04L 7/00

(52) U.S. Cl. 375/359

(57) ABSTRACT

Disclosed is a detector and method for detecting symbol timing synchronization in a digital communication system or an analog communication system. There is provided a detector and method for detecting symbol timing synchronization of a received signal in a communication device, in which a signal is generated by multiplying: i) a received signal or its time delayed signal, and ii) any one of a signal obtained by adding the time delayed signal to the received signal or subtracting the time delayed signal from the received signal, a signal obtained by Hilbert transforming the received signal, and a signal obtained by differentiating the received signal, and the detector outputs the generated signal as a signal for determining symbol timing synchronization. The detector and method for detecting symbol timing synchronization according to the present invention may be efficiently applied to a high order modulation system of highly bandwidth efficient systems, such as a communication system utilizing a QAM or OFDM modulation method. In particular, the detector according to the present invention may be applied to a digital signal and an analog signal, and a digital signal which is similar to an analog signal because of dense data symbols. The detector is not affected by data and carrier frequency. The superiority of its performance may be confirmed from a timing synchronization detector characteristic

### TECHNICAL FIELD

The present invention relates to a detector and method for detecting symbol timing synchronization in a digital communication system or an analog communication system. More particularly, the present invention relates to a detector and method for detecting symbol timing synchronization in a communication device, in which a signal is generated by multiplying: i) a received signal or its time delayed signal, and ii) any one of a signal obtained by adding the time delayed signal to the received signal or subtracting the time delayed signal from the received signal, a signal obtained by Hilbert transforming the received signal, and a signal obtained by differentiating the received signal, and the detector outputs the generated signal as a signal for de- termining symbol timing synchronization.

### BACKGROUND ART

The purpose of symbol timing recovery is to recover a clock to sample a received continuous waveform as part of data recovery. Symbol timing information is included in a received waveform of digital communication systems. Accordingly, the symbol timing information needs to be extracted by signal processing. For digital com- munication systems, as described above, it is very important to extract symbol timing information, synchronize a symbol to the extracted symbol timing information and accurately sample the symbol. Accordingly, various types of timing synchronization detectors have been developed [refer to E. A. Lee and D. G. Messerschmidt, “Digital Communication-second edition,” Kluwer Academic Publishers, 1994 chapter 17. Timing Recovery].

However, in the case of the aforementioned conventional timing synchronization detectors, a detection signal gain is small and bandwidth efficiency is also low. Accordingly, the conventional symbol timing synchronization detectors may not be applicable to digital communication systems in which data symbols are very dense, thus the signal is similar to that of an analog circuit. In particular, small gain makes it inapplicable to a digital signal with dense data symbols, thus approaching an analog signal (e.g., quadrature amplitude modulation (QAM) method or orthogonal frequency division multiplexing (OFDM) modulation method).

### DISCLOSURE OF INVENTION

### Technical Problem

The present invention is conceived to solve the aforementioned problems, and the present invention provides a detector and method for detecting symbol timing synchronization, in which a signal is generated by multiplying: i) a received signal or its time delayed signal, and ii) any one of a signal obtained by adding the time delayed signal to the received signal or subtracting the time delayed signal from the received signal, a signal obtained by Hilbert transforming the received signal, and a signal obtained by differentiating the received signal, and the detector outputs the generated signal as a signal for determining symbol timing synchronization.

The present invention also provides a detector and method for detecting symbol timing synchronization which can be applied to highly bandwidth efficient communication systems with a high order modulation independent of carrier phase and frequency, without data aid and not based on an equalizer. Also, timing may be quickly recovered. Namely, symbol timing is first recovered, decoupled from carrier recovery, equalizer and data. Also, the present invention is based on correlation. Accordingly, it is possible to remove jitter or self-noise which is a significant matter in high order modulation.

In summary, the present invention provides a detector and method for detecting symbol timing synchronization of a received signal in a communication device.

### Technical Solution

To achieve the above objectives and solve the aforementioned problems in the conventional art, according to an aspect of the present invention, there is provided a detector and method for detecting symbol timing, which can generate a signal by multiplying: i) a received signal or its time delayed signal, and ii) any one of a signal obtained by adding the time delayed signal to the received signal or subtracting the time delayed signal from the received signal, a signal obtained by Hilbert transforming the received signal, and a signal obtained by differentiating the received signal, and output the generated signal as a signal for determining symbol timing synchronization.

More particularly, there is provided a detector and method for detecting symbol timing synchronization, which can generate a signal by multiplying: i) a one-and-a-half symbol period delayed signal with respect to the received signal, and ii) a signal obtained by subtracting a one symbol period delayed signal with respect to the received signal from the received signal, adding a two symbol period delayed signal with respect to the received signal to the result of the subtraction, and subtracting a three symbol period delayed signal with respect to the received signal from the result of the addition, and output the generated signal as a signal for determining symbol timing synchronization.

According to another aspect of the present invention, there is provided a detector and method for detecting symbol timing synchronization, which can generate a signal A by multiplying: i) a) a half symbol period delayed signal with respect to the received signal, and b) a signal obtained by subtracting a one symbol period delayed signal with respect to the received signal, from the received signal; and generate a signal B by multiplying: ii) a) a quarter symbol period delayed signal with respect to the received signal, and b) a signal obtained by subtracting a one-and-a-quarter symbol period delayed signal with respect to the received signal from said a quarter symbol period delayed signal with respect to the received signal, and generate a signal by adding: iii) the signal A and the signal B, and output the generated signal as a signal for determining symbol timing synchronization.

According to yet another aspect of the present invention, there is provided a detector and method for detecting symbol timing synchronization, which can generate a signal by multiplying: i) the received signal, and ii) the signal obtained by Hilbert transforming the received signal, or a signal obtained by differentiating the received signal, and output the generated signal as a signal for determining symbol timing synchronization.

### BRIEF DESCRIPTION OF THE DRAWINGS

The above and/or other aspects and advantages of the present invention will become apparent and more readily appreciated from the following detailed description, taken in conjunction with the accompanying drawings of which:

FIGS. 1 and 2 are graphs illustrating a gain value C₁(Δ) calculated with respect to a raised cosine pulse and a pre-filtered raised cosine pulse, respectively;

FIG. 3 is a configuration diagram of a timing synchronization detector using a conventional wave difference algorithm;

FIG. 4 is a configuration diagram of a timing synchronization detector according to a first embodiment of the present invention;

FIG. 5 is a configuration diagram of a timing synchronization detector according to a second embodiment of the present invention;

FIG. 6 is a configuration diagram of a circuit for recovering timing synchronization by using a timing synchronization detector according to the present invention;

FIG. 7 is a configuration diagram of a timing synchronization detector according to a third embodiment of the present invention;

FIG. 8 is a configuration diagram of a timing synchronization detector according to a fourth embodiment of the present invention; and

FIG. 9 is a constellation of 1536-QAM which may utilize the detector and method for detecting timing synchronization according to the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures. Also, in the present invention, the frequency bandwidth is limited and it is assumed that a signal is a real and an even function in time domain.

To extract symbol timing information, a correlation value is generally obtained by multiplying a received signal and its delayed signal and taking an average with an ideal impulse response. As an example for the impulse response, as illustrated in Table 1, a raised cosine pulse and pre-filtered raised cosine pulse is used.

TABLE 1
Raised cosine pulse & pre-filtered raised cosine pulse

| | Raised Cosine Pulse | Pre-filtered Raised cosine pulse |
|---|---|---|
| Timedomain | ${h}_{RC} ( t ) = \frac{sin ( \frac{πt}{T} )}{\frac{πt}{T}} \frac{cos ( \frac{βπt}{T} )}{1 - 4 {( \frac{βt}{T} )}^{2}}$ | ${h}_{pf} ( t ) = \frac{sin ( \frac{βπt}{T} )}{\frac{πt}{T}} \frac{cos ( \frac{πt}{T} )}{1 - {( \frac{βt}{T} )}^{2}}$ |
| Frequencydomain | $\begin{matrix}{H}_{RC} ( f ) = T \\ = \frac{T}{2} \{ 1 + cos \frac{πT}{β} ( f - \frac{1 - β}{2 T} ) \} \\ = \frac{T}{2} \{ 1 + cos \frac{πT}{β} ( f + \frac{1 - β}{2 T} ) \}\end{matrix}$ | $\begin{matrix}{H}_{RC} ( f ) = 0 \vert f \vert < \frac{1 - β}{2 T} \\ = {Tcos}^{2} \frac{πT}{β} ( f - \frac{1}{2 T} ) \frac{1 - β}{2 T} < f < \frac{1 + β}{2 T} \\ = {Tcos}^{2} \frac{πT}{β} ( f + \frac{1}{2 T} ) - \frac{1 + β}{2 T} < f < - \frac{1 - β}{2 T}\end{matrix}$ |

Self-noise may become serious as the order of modulation level gets higher, but it can be substantially eliminated by using a pre-filter.

In the case of detection and recovery of symbol timing synchronization in a pulse amplitude modulation (PAM) or a quadrature amplitude modulation (QAM), a received signal via a matched filter is represented as,

$$z ( t - τ ) = {\sum }_{k = - ∞}^{k = ∞} {a}_{k} h ( t - τ - kT ) + n ( t ) \qquad [ Expression 1 ]$$

In Expression 1, h(t) is the impulse response and defined as

h(t)=h_{T}(t)\textcircled{×}h_{R}(t)

where \textcircled{×}

denotes convolution, h_{T}(t) is an impulse response of transmit side and h_{R}(t) is an impulse response of receive side. Also, τ is a delay time through transmission and needs to be estimated at a receiver. Also, [aₖ] is a sequence of digital symbols to be transmitted. In this instance, it is assumed that the average power is unity, i.e., E{|a|²}=1.0 where E{ } denotes an average operator.

{aₖ}={+1, −1} for a binary phase shift keying (BPSK) and {aₖ}={+1, −1, +j, −j} for a quadrature phase shift keying (QPSK). However, the symbol timing synchronization detector according to the present invention may be applied to both an analog signal and a digital signal, in particular, a digital signal which is similar to an analog signal because of dense data symbols. Accordingly, it is assumed that said aₖ may have a discrete value and a continuous analog value. As an example, {aₖ}={normal distribution with unity variance} or {aₖ}={uniform distribution

−\sqrt{3}

to

+\sqrt{3}

with unity variance}. {aₖ} may be a real number and extended to a complex number such as those in QAM. In this case, real components of I and Q are used.

Correlation is an expectation value of a multiplication of a received signal z(t) and its delayed signal

z(t∓ΔT),

and defined as,

$$\begin{matrix}E \{ z ( t ) z ( t ∓ Δ T ) \} = {\sum }_{k = - ∞}^{k = ∞} {\sum }_{l = - ∞}^{l = ∞} E \{ {a}_{k} {a}_{l} \} h ( t - kT ) \\ h ( t ∓ Δ T - lT ) + E \{ {n}^{2} ( t ) \} \\ = E \{ {a}^{2} \} {\sum }_{k = - ∞}^{k = ∞} h ( t - kT ) h ( t ∓ Δ T - kT ) + σ\end{matrix} \qquad [ Expression 2 ]$$

In Expression 2, in the case of Δ=0, it corresponds to squaring algorithm.

Symbol timing recovery is essentially based on its periodic characteristic. Accordingly, the characteristic of the symbol timing detector may be understood by examining

S(∓ΔT)

or S_{Δ} represented as Expression 3. In this instance, S_{Δ} is a timing synchronization detection waveform without noise and called an S-curve.

$$S ( ∓ Δ T ) = {\sum }_{k = - ∞}^{k = ∞} h ( t - kT ) h ( t ∓ Δ T - kT ) \qquad [ Expression 3 ]$$

In Expression 3, T is a period.

Expression 4 below may be induced by Poisson Sum Formula,

$${\sum }_{n = - ∞}^{n = ∞} h ( t - nT ) h ( t - Δ T - nT ) = {\sum }_{m = - ∞}^{m = ∞} [ \frac{1}{T} {\int }_{v = - ∞}^{v = ∞} H ( \frac{m}{T} - v ) H ( v ) {e}^{- j2πΔ T v} d v ] {e}^{j \frac{2 π}{T} mt} \qquad [ Expression 4 ]$$

In Expression 4, H(f) is a Fourier transform of h(t).

With the assumptions that the bandwidth of H(f) is limited and h(t) is a real and even function and considering only m=0, ±1, Expression 3 may be represented as,

$$S ( ∓ Δ T ) = {\sum }_{m = - ∞}^{m = ∞} [ \frac{1}{T} {\int }_{v = - ∞}^{v = ∞} H ( \frac{m}{T} - v ) H ( v ) {e}^{∓ j2πΔ Tv} d v ] {e}^{j \frac{2 π}{T} mt} \qquad [ Expression 5 ]$$

Also, Expression 5 may be arranged as,

$$S ( ∓ Δ T ) = \frac{2}{T} {\int }_{0}^{\frac{1}{T}} {\vert H ( v ) \vert}^{2} cos ( 2 π Δ Tv ) d v + [ \frac{2}{T} {\int }_{0}^{\frac{1}{T}} H ( \frac{1}{T} - v ) H ( v ) cos ( 2 πΔ Tv ) d v ] cos ( \frac{2 π t}{T} ) + [ \frac{2}{T} {\int }_{0}^{\frac{1}{T}} H ( \frac{1}{T} - v ) H ( v ) sin ( 2 πΔ Tv ) d v ] sin ( \frac{2 π t}{T} ) = {C}_{0} ( Δ ) + {A}_{1} ( Δ ) cos ( \frac{2 π t}{T} ) + {B}_{1} ( Δ ) sin ( \frac{2 π t}{T} ) \qquad [ Expression 6 ]$$

In this case, by substituting integral variable

$$y = ( vT - \frac{1}{2} )$$

and assuming that h(t) is even symmetrical in time domain and

$$H ( \frac{1}{T} - v ) H ( v )$$

is even symmetrical around

$$\frac{1}{2 T}$$

### Expression 6 may be reduced to,

$$\begin{matrix}S ( ∓ Δ T ) = {C}_{0} ( Δ ) + [ \frac{2}{{T}^{2}} {\int }_{- 0.5}^{0.5} H ( \frac{y + 0.5}{T} ) H \\ ( \frac{- y + 0.5}{T} ) cos ( 2 πΔ y ) d y ] cos ( \frac{2 π t}{T} ∓ πΔ ) \\ = {C}_{0} ( Δ ) + {C}_{1} ( Δ ) cos ( \frac{2 π t}{T} ∓ πΔ )\end{matrix} \qquad [ Expression 7 ]$$

In Expression 7, the integrand of C₁ is an even function of y and Δ.

S(∓ΔT)

according to special values of Δ may be represented as,

$$\begin{matrix}Δ = 0 , \pm 1 , \pm 2 , … S ( ∓ Δ T ) = {C}_{0} ( Δ ) + {C}_{1} ( Δ ) {( - 1 )}^{\vert Δ \vert} cos ( \frac{2 π t}{T} ) , & [ Expression 8 ] \\ Δ = \pm \frac{1}{2} , \pm \frac{3}{2} , \pm \frac{5}{2} , … S ( ∓ Δ T ) = {C}_{0} ( Δ ) + {C}_{1} ( Δ ) sgn ( Δ ) {( - 1 )}^{\vert Δ \vert - \frac{1}{2}} sin ( \frac{2 π t}{T} ) , & [ Expression 9 ] \\ \vert Δ \vert = ɛ \leq \frac{1}{2} S ( ∓ Δ T ) = {C}_{0} ( Δ ) + {C}_{1} ( Δ ) cos ( \frac{2 π t}{T} ∓ ɛπ ) \\ 0 \leq ɛ \leq \frac{1}{2} , \\ and & [ Expression 10 ] \\ \frac{1}{2} \leq \vert Δ \vert \leq 1 \\ S ( ∓ Δ T ) = {C}_{0} ( Δ ) + {C}_{1} ( Δ ) sgn ( Δ ) sin ( \frac{2 π t}{T} ∓ ɛπ ) \\ 0 \leq ɛ \leq \frac{1}{2} & [ Expression 11 ]\end{matrix}$$

Examples of Expressions 8 and 9 are shown in Tables 2 and 3, in the two cases of

$$t -> t ∓ \frac{T}{2}$$

$$and$$

$$t -> t ∓ \frac{T}{4}$$

In this instance, each case means a half symbol delay/early with respect to a received signal, and a quarter symbol delay/early with respect to a received signal. The half symbol delay negates the coefficients of cosine and sine terms, and the quarter symbol delay exchanges the coefficients of cosine and sine terms with each other.

TABLE 2
${\sum }_{n = - ∞}^{n = ∞} h ( t - nT ) h ( t ∓ ΔT - nT ) = {C}_{0} + {A}_{1} cos ( \frac{2 πt}{T} ) + {B}_{1} sin ( \frac{2 πt}{T} )$

| Δ =+ meansdelay, −means early | t → t | | $\begin{matrix}t \to t ∓ \frac{T}{2} \\ negation\end{matrix}$ | | $\begin{matrix}t \to t ∓ \frac{T}{4} \\ {A}_{1} ↔ {B}_{1}\end{matrix}$ | |
|---|---|---|---|---|---|---|
| Δ | A₁ | B₁ | A₁ | B₁ | A₁ | B₁ |
| 0 | + | 0 | − | 0 | 0 | ± |
| ±1 | − | 0 | + | 0 | 0 | ∓ |
| ±2 | + | 0 | − | 0 | 0 | ± |
| ±3 | − | 0 | + | 0 | 0 | ∓ |
| $\pm \frac{1}{2}$ | 0 | ± | 0 | ∓ | ± | 0 |
| $\pm \frac{3}{2}$ | 0 | ∓ | 0 | ± | ∓ | 0 |
| $\pm \frac{5}{2}$ | 0 | ± | 0 | ∓ | ± | 0 |

C₁(Δ) of Table 3 below, which is a pulse gain for two h(t) cases, is substituted. One is a gain for a raised cosine pulse with an excess bandwidth β and the other is its pre-filtered raised cosine pulse gain.

TABLE 3

| | |
|---|---|
| raised cosine | $2 {C}_{1}^{RC} ( Δ ) = \frac{β}{2 Γ ( 2 + Δβ ) Γ ( 2 - Δβ )}$ |
| pre-filtered RC | $2 {C}_{1}^{p RC} ( Δ ) = \frac{6 β}{Γ ( 3 + Δβ ) Γ ( 3 - Δβ )}$ |

The value of C₁(Δ) is computed by using a table of definite integrals with respect to Expression 12 below,

$${\int }_{0}^{\frac{π}{2}} {cos}^{m - 1} x cos ax d x = \frac{π}{{2}^{m} mB ( \frac{m + a + 1}{2} , \frac{m - a + 1}{2} )} \qquad [ Expression 12 ]$$

In Expression 12,

$$B ( u , v ) = \frac{Γ ( u ) Γ ( v )}{Γ ( u + v )} .$$

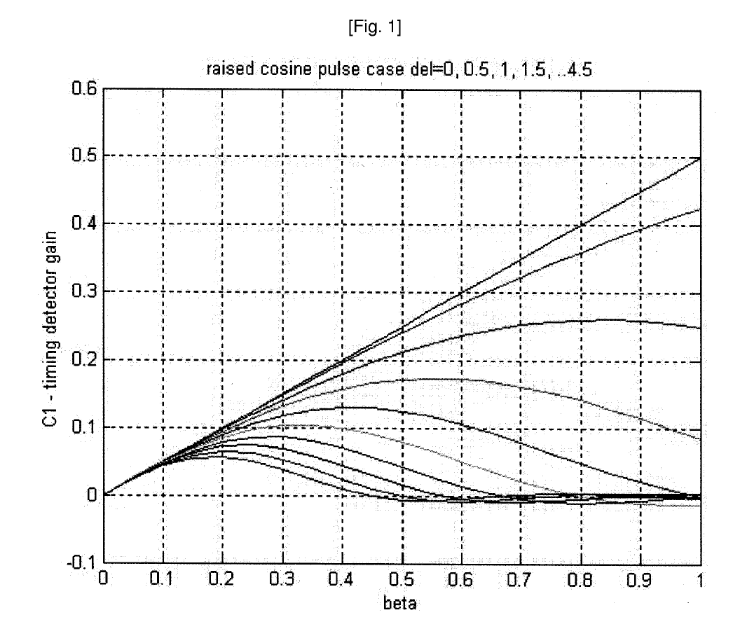

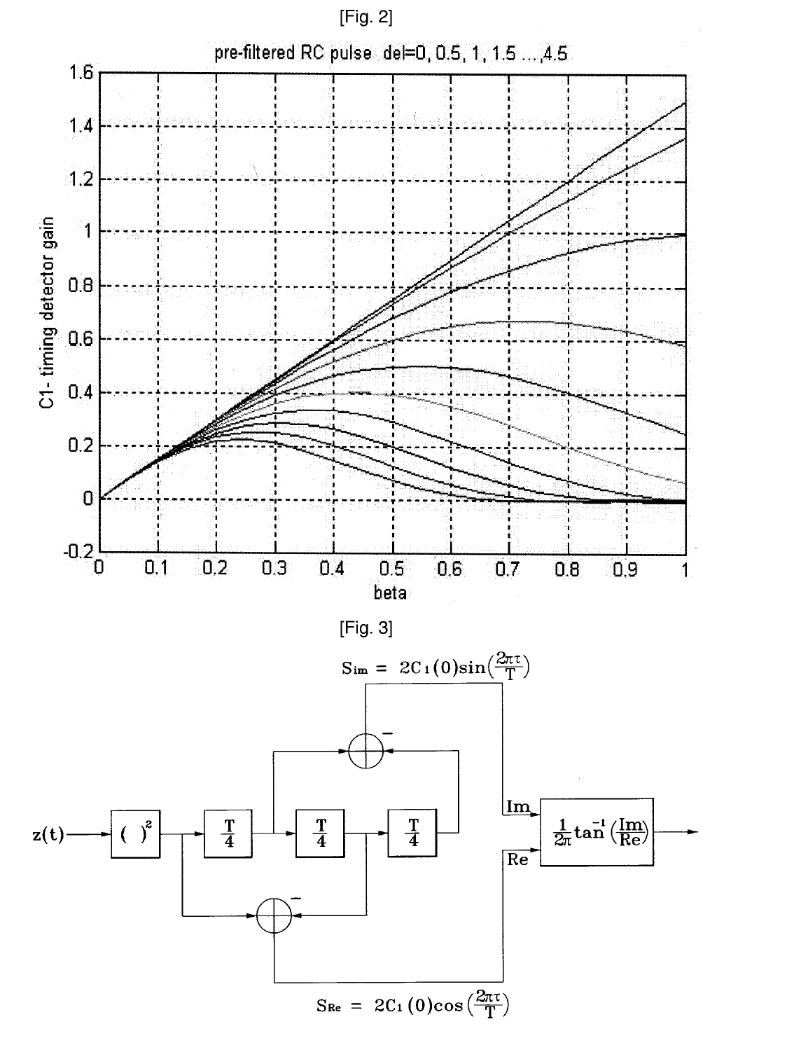

The values of C₁(Δ) computed with respect to the raised cosine pulse and its pre-filtered raised cosine pulse are illustrated in FIGS. 1 and 2.

Referring to FIGS. 1 and 2, it can be seen that there is no sign change except for when the value of C₁(Δ) is near zero. Also, a detection signal gain increases by adding signals with appropriate signs in communication systems with high order modulation having different correlation values. As an example, in the case of selecting and coupling a plurality of delay times A to make the S-curve become a trigonometric function of the same type, same sign, a detection signal gain may be increased. Accordingly, various types of detection circuits increasing a detection signal gain may be designed.

Accordingly, a timing detection wave(S-curve) may be computed according to a correlation between a received signal or a signal delayed by a certain amount of symbol period(first symbol delay) with respect to the received signal, and a signal delayed by a certain amount of symbol period(second symbol delay) with respect to the received signal. And, the first symbol delay and the second symbol delay may be determined in order that the computed timing detection wave may become a trigonometric function of the same type and same sign. A detector for detecting symbol timing synchronization may be designed in this way.

Hereinafter, representative timing synchronization detection algorithms in the conventional art will be described using the aforementioned concept of S-curve.

The impulse response h(t) is assumed to be a real and even function in time domain, with a limited frequency bandwidth. For convenience of mathematical expression, a raised cosine pulse and a pre-filtered raised cosine pulse are used.

A wave difference method is disclosed in [O. Agazzi, C.-P. J. Tzeng, D. G. Messerschmitt, and D. A. Hodges, “Timing recovery in Digital Subscriber loops”, IEEE Trans. Commun., vol. COM-33, pp. 558-569, June 1985]. By using Table 2, timing synchronization detector S-curve may be found as follows.

In Table 2, Δ=0 row and A₁ column has “+” which means that only the cosine term. A half symbol delay column has “Δ sign, which means the cosine term with negative sign. The subtraction from “+” to “Δ will cancel C₀DC term and leave the desired term S=2C₁(0)cos(2πτ/T). In this case, said S may be changed to S=2C₁(0)sin(2πτ/T) by delaying u(τ) by a quarter symbol period as shown in Table 2. The configuration of the timing synchronization detector described above is illustrated in FIG. 3.

The timing synchronization detector constructed as in FIG. 3 may be obtained by two seemingly different approaches. The first method is based on reference [M. Oerder and H. Meyer, Digital Filter and Squaring Timing Recovery, IEEE Trans. Commun., vol. COM-36, pp. 605-612, May 1988]. A timing synchronization detector algorithm is described as,

$${ɛ}_{m} = - \frac{1}{2 π} \text{arg} ( {\sum }_{k = mLN}^{( m + 1 ) L N - 1} {\vert {z}_{k} \vert}^{2} {e}^{- j \frac{2 π k}{N}} ) \qquad [ Expression 13 ]$$

In Expression 13, εₘ∈{−0.5, 0.5} is a timing error, and zₖ is a value obtained by sampling a received signal.

Also, N is samples per symbol and L is the number of symbols in the m^{th} time segment.

The above algorithm is used in the case of 4 samples per symbol. In the case of N=4, the algorithm may be implemented in the simplest form.

The second method is based on early-late gate approximation of maximum likelihood (ML) timing detector. u(t)=z²(τ+εT)−z²(τ−εT) is used. In principle, an absolute value rather than a squaring value is used, but herein it is modified for easy comparison.

S-curve may be computed by using Table 2. S=−2C₁(0)sin(2πε)sin(2πτ/T) may be given by using Expression 7 and delay time

∓εT .

### The result is obtained by selecting ε=¼.

Also, Gardner detector [F. M. Gardner, “A BPSK/QPSK Timing-error Detector for Sampled Receivers”, IEEE Trans. Commun., vol. COM-34, pp. 423-429, May 1986], which is a conventional timing synchronization detector, may be described by using the concept of S-curve, as described above. The Gardner detector also may obtain S-curve by modifying Table 2. In the case of Δ=−½ and Δ=+½ and taking the difference, both terms are delayed by a half of symbol period.

Hereinafter, an example of the timing synchronization detector according to the present invention will be described. The detector according to the present invention may significantly increase a detection signal gain in comparison with the aforementioned conventional timing synchronization detector.

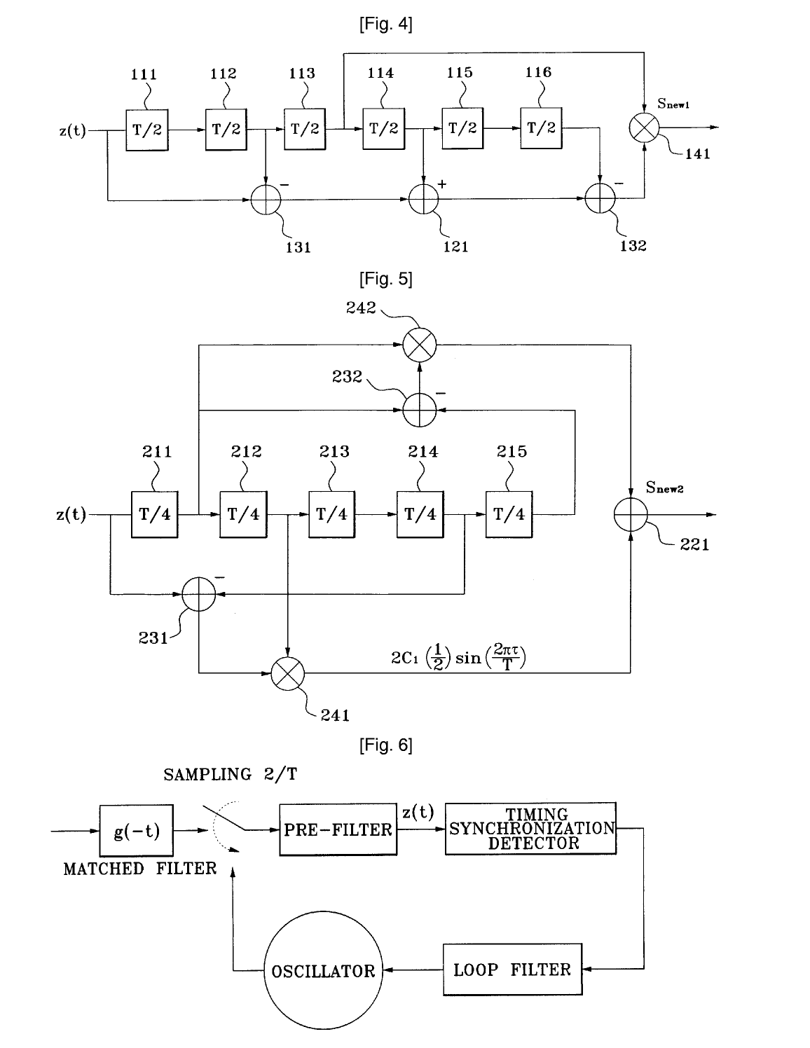

Below, u_{new1}(T) is a timing synchronization detection algorithm according to a first embodiment of the present invention. FIG. 4 illustrates a configuration of the timing synchronization detector as described above.

$${u}_{new 1} ( τ ) = z ( τ - \frac{3 T}{2} ) [ z ( τ ) - z ( τ - T ) + z ( τ - 2 T ) - z ( τ - 3 T ) ]$$

In the present invention, it is assumed that the frequency bandwidth is limited, and a signal is a real and even function in time domain. With the above assumptions, a timing synchronization detection curve, i.e., S-curve computed by using Table 2 is given by,

$${S}_{new 1} = [ 2 {C}_{1} ( \frac{1}{2} ) + 2 {C}_{1} ( \frac{3}{2} ) ] sin ( \frac{2 πτ}{T} )$$

The timing synchronization detector includes a first delay line 111 delaying a received signal z(t) by a half symbol period, a second delay line 112 delaying an output of the first delay line 111 by a half symbol period, a third delay line 113 delaying an output of the second delay line 112 by a half symbol period, a fourth delay line 114 delaying an output of the third delay line 113 by a half symbol period, a fifth delay line 115 delaying an output of the fourth delay line 114 by a half symbol period, and a sixth delay line 116 delaying an output of the fifth delay line 115 by a half symbol period; a first subtracter 131 subtracting the output of the second delay line 112 from the received signal z(t); an adder 121 adding the output of the first subtracter 131 to the output of the fourth delay line 114; a second subtracter 132 subtracting the output of the sixth delay line 116 from the output of the adder 121; and a multiplier 141 multiplying the output of the third delay line 113 and the output of the second subtracter 132.

As described above, a detection signal gain may be increased by appropriately adding more terms to be correlated. In the first embodiment, two samples per symbol.

Four samples per symbol may be embodied according to a second embodiment of the present invention as below. Below, u_{new2}(T) is the timing synchronization detection algorithm according to the second embodiment of the present invention. FIG. 5 illustrates a configuration of the timing synchronization detector as described above.

$${u}_{new 2} ( τ ) = z ( τ - \frac{T}{2} ) [ z ( τ ) - z ( τ - T ) ] + z ( τ - \frac{T}{4} ) [ z ( τ - \frac{T}{4} ) - z ( τ - \frac{5 T}{4} ) ]$$

S-curve computed by using Table 2 is given by,

$${S}_{new 2} = [ 2 {C}_{1} ( 0 ) + 2 {C}_{1} ( \frac{1}{2} ) ] sin ( \frac{2 πτ}{T} )$$

The timing synchronization detector includes: a first delay line 211 delaying a received signal z(t) by a quarter symbol period, a second delay line 212 delaying an output of the first delay line 211 by a quarter symbol period, a third delay line 213 delaying an output of the second delay line 212 by a quarter symbol period, a fourth delay line 214 delaying an output of the third delay line 213 by a quarter symbol period, and a fifth delay line 215 delaying an output of the fourth delay line 214 by a quarter symbol period; a first subtracter 231 subtracting the output of the fourth delay line 214 from the received signal z(t); a first multiplier 241 multiplying the output of the second delay line 212 and the output of the first subtracter 231; a second subtracter 232 subtracting the output of the fifth delay line 215 from the output of the first delay line 211; a second multiplier 242 multiplying the output of the first delay line 211 and the output of the second subtracter 232; and an adder 221 adding the output of the second multiplier 242 to the output of the first multiplier 241.

Also, a detection signal gain may be increased by appropriately adding more terms to be correlated.

As described above, a signal for determining symbol timing synchronization may be produced by a linear combination of the signals obtained by multiplying a received signal or a signal delayed by a certain amount of symbol period(first symbol delay) with respect to the received signal, and a signal delayed by a certain amount of symbol period(second symbol delay) with respect to the received signal.

Through the above-described two embodiments, the symbol timing synchronization detector which increases its gain, without noise, and samples two or four samples per symbol is embodied digitally. The detector curve is a straight line by using cosine and sine terms. Also, an instantaneous timing error phase may be measured with four samples. The detector curve is a straight line up to T/2. The timing synchronization detector described above is free of hang up, which is a phenomenon of not recovering timing synchronization and remaining in one condition. Rather, the timing synchronization detector may quickly recover timing synchronization.

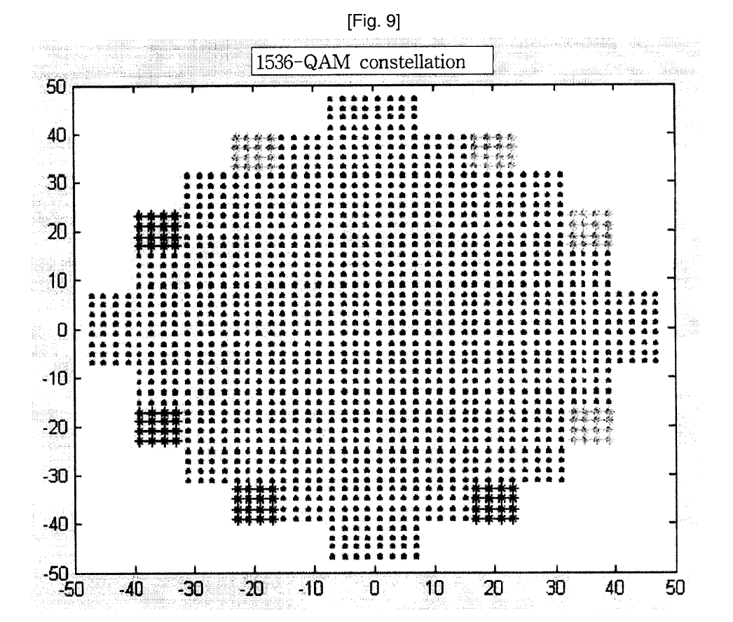

The timing synchronization detector according to the present invention may be applicable to PAM or QAM, such as, 16-QAM, 64-QAM, 256-QAM, 512-QAM, 1024-QAM, or, as illustrated in FIG. 9, 1536-QAM. Also, the timing synchronization detector according to the present invention may be applicable to PSK or FSK, which is used in code division multiple access (CDMA) systems.

Also, in the case of using a high order modulation method to improve bandwidth efficiency, symbols are extremely dense which results in a digital signal very similar to an analog signal. As an example, an OFDM signal used in mobile Internet access.

OFDM may simultaneously carry subcarriers with one symbol. The number of subcarriers corresponds to the number of fast Fourier transform (FFT) points. Sampled signal in the OFDM is a superposition of multiple signals up to the number of FFT points, which is similar to an analog signal. The timing synchronization detector according to the present invention may be applicable to OFDM and may recover an OFDM symbol and sampling time in which the OFDM symbol is divided by the number of FFT points.

Also, the timing synchronization detector according to the present invention may be applied to sampled data systems in which a sampled value for discrete time intervals is an analog value. Namely, the timing synchronization detector may be applied, when a signal is sampled at discrete time intervals, even with a signal value which has an analog value.

FIG. 6 illustrates a configuration of a device for recovering symbol timing from a signal for determining symbol timing synchronization according to the present invention, in which the signal for determining symbol timing synchronization is outputted from a symbol timing synchronization detector.

As described in FIG. 6, the device for recovering symbol timing may include a symbol timing detector which outputs a signal for determining symbol timing synchronization, and a recovering means which recovers a symbol timing based on the output signal for determining the symbol timing synchronization.

As an example, the recovering means may include a matched filter, an oscillator, and a loop filter. A clock is recovered by the loop filter and the oscillator using the output signal for determining the symbol timing synchronization, and data are recovered from the received signal by sampling the matched filter output according to the recovered clock.

In this instance, a time domain function may be replaced for symbol delay which is used in the first and second embodiments. Namely, a signal obtained by multiplying a received signal and its time domain function may be used as a signal for determining symbol timing synchronization.

As shown in the embodiments of FIGS. 4 and 5, a detector for detecting symbol timing synchronization based on the present invention may output a linear combination of signals generated by multiplying a received signal and, a time domain function output of the received signal as a signal for determining symbol timing synchronization.

As an example, a signal itself (i.e., a square function), a delay function (a delayed signal), a differential operator and a Hilbert transformer may be used as a function.

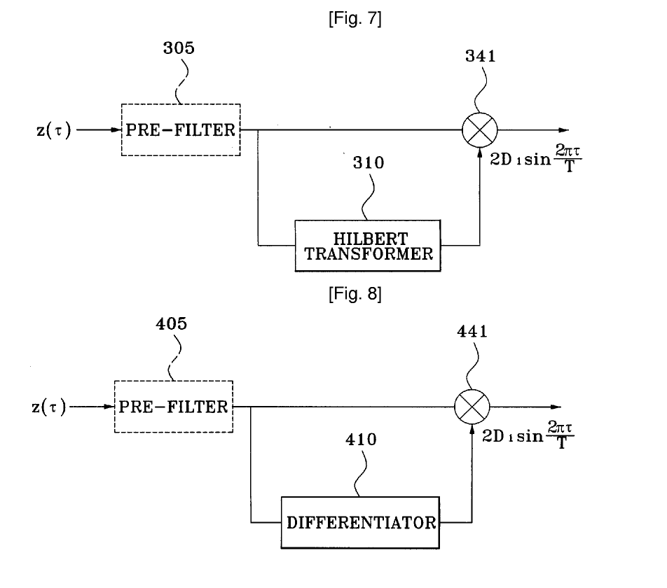

FIG. 7 illustrates a configuration of a timing synchronization detector according to a third embodiment of the present invention, in which a Hilbert transformer is used.

The timing synchronization detector includes a Hilbert transformer 310 Hilbert transforming a received signal z(τ); and a multiplier 341 multiplying an output of the Hilbert transform 310 and the received signal Z(τ).

FIG. 8 illustrates a configuration of a timing synchronization detector according to a fourth embodiment of the present invention, in which a differentiator is used.

The timing synchronization detector includes a differentiator 410 differentiating the received signal Z(τ); and a multiplier 441 multiplying an output of the differentiator 410 and the received signal Z(τ).

In this case, a half symbol and a quarter symbol delay is applicable. Also, pre-filters 305 and 405 may be included to remove noise from a received signal.

Table 4 below shows an algorithm and detector curve of a timing synchronization detector using a Hilbert transform and differentiation.

Table 4 Algorithm and S-curve in the case of applying Hilbert transform and differentiation

| | Algorithm | |
|---|---|---|
| | $z ( t ) = {\sum }_{- ∞}^{∞} {a}_{k} h ( t - kT ) + n ( t )$ | S-curve |
| Hilbert transform | $\begin{matrix} u ( τ ) = z ( τ ) \{ \hat{z} ( τ ) \} , \\ where \hat{z} ( t ) = \frac{1}{πt} ⊗ z ( t ) \\ \begin{matrix}{H}_{transform} ( f ) = - j f > 0 \\ = 0 f = 0 \\ = + j f < 0\end{matrix}\end{matrix}$ | $\begin{matrix}{S}_{Hilbert} = + 2 [ \frac{1}{T} {\int }_{0}^{\frac{1}{T}} H ( \frac{1}{T} - v ) H ( v ) dv ] sin \frac{2 πτ}{T} \\ = + 2 {D}_{1} sin \frac{2 πτ}{T}\end{matrix}$ |
| Differentiation | $u ( τ ) = z ( τ ) \{ \frac{d}{d τ} Z ( τ ) \}$ | ${S}_{Diff} = - 2 [ \frac{2 π}{T} {\int }_{0}^{\frac{1}{T}} H ( \frac{1}{T} - v ) H ( v ) vdv ] sin \frac{2 πτ}{T}$ |

For both timing synchronization detectors according to the third and the fourth embodiments, there is no DC component.

S_{Hilbert}, an S-curve in the case of Hilbert transforming, has the same gain as the squaring method, except for a sine function rather than a cosine function.

The timing synchronization detector according to the third embodiment using the Hilbert transformer is related to band edge timing recovery (BETR) which is used in a fast voice band modem. In BETR, a received signal is band pass filtered at ½T and, in parallel, filtered at −½T. The former and the latter are multiplied to generate a timing synchronization detection signal.

The band pass filter is an approximation to pre-filtering. The band pass filter is applied on a real signal of IF frequency or equivalently in base band with a complex envelope signal which may be considered as IF frequency is zero. The upper side band is represented as

$$\frac{1}{2} \{ h ( t ) + j \hat{h} ( t ) \}$$

### Also, the lower side band is represented as

$$\frac{1}{2} \{ h ( t ) - j \hat{h} ( t ) \}$$

in which

ĥ(t)

is a Hilbert transform of h(t). Accordingly, a timing signal of BETR may be represente d as,

$$B E T R timing signal = Im \{ \frac{1}{2} ( h ( t ) + j {\hat{h} ( t ) [ \frac{1}{2} \text{(} h ( t ) - j \hat{h} ( t ) ]}^{*} \} = h ( t ) \hat{h} ( t ) \qquad [ Expression 14 ]$$

It is embodied by the timing synchronization detector according to the third embodiment using Hilbert transform.

As a substitute, Expression 15 below may be used, but will be the same as squaring. Also, since DC is contained, Expression 15 is not generally used.

$$B E T R timing signal = Re \{ \frac{1}{2} \text{(} h ( t ) + j \hat{h} ( t ) [ \frac{1}{2} \text{(} h ( t ) - j \hat{h} ( t ) ] \} = {h}^{2} ( t ) + {\hat{h}}^{2} ( t ) \qquad [ Expression 15 ]$$

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

A timing synchronization detector according to the present invention uses a correlation with a delayed signal and a correlation with a general function such as Hilbert transform. The detector according to the present invention may be applied to highly bandwidth efficient modulation systems, such as QAM or OFDM systems. Also, the timing synchronization detector according to the present invention is suitable for fast timing recovery, being independent of carrier phase and frequency. Also, even when a digital signal is similar to an analog signal because of dense data symbols, the timing synchronization detector according to the present invention may be applied.

A symbol timing detector according to the present invention is not affected by data and carrier frequency. The superiority of its performance may be confirmed from a timing synchronization detector characteristic curve.

1. A detector for detecting symbol timing synchronization of a received signal in a communication device, the detector generating a signal by multiplying:
i) a received signal or its time delayed signal, and ii) any one of a signal obtained by adding the time delayed signal to the received signal or subtracting the time delayed signal from the received signal, a signal obtained by Hilbert transforming the received signal, and a signal obtained by differentiating the received signal,
wherein the detector outputs the generated signal as a signal for determining symbol timing synchronization.

2. The detector of claim 1, generating a signal by multiplying:
i) a one-and-a-half symbol period delayed signal with respect to the received signal, and ii) a signal obtained by subtracting a one symbol period delayed signal with respect to the received signal from the received signal, adding a two symbol period delayed signal with respect to the received signal to the result of the subtraction, and subtracting a three symbol period delayed signal with respect to the received signal from the result of the addition,
wherein the detector outputs the generated signal as a signal for determining symbol timing synchronization.

3. The detector of claim 2, comprising:
at least one delay line delaying the received signal by a half symbol period; and
an adder, a subtracter, and a multiplier.

4. The detector of claim 3, comprising:
a first delay line delaying the received signal by a half symbol period,
a second delay line delaying an output of the first delay line by a half symbol period,
a third delay line delaying an output of the second delay line by a half symbol period,
a fourth delay line delaying an output of the third delay line by a half symbol period,
a fifth delay line delaying an output of the fourth delay line by a half symbol period, and
a sixth delay line delaying an output of the fifth delay line by a half symbol period;
a first subtracter subtracting the output of the second delay line from the received signal;
an adder adding an output of the first subtracter to the output of the fourth delay line;
a second subtracter subtracting an output of the sixth delay line from an output of the adder; and
a multiplier multiplying the output of the third delay line and an output of the second subtracter.

5. A method for detecting symbol timing synchronization of a received signal in a communication device, the method comprising the steps of:
(a) subtracting a one symbol period delayed signal with respect to the received signal from the received signal;
(b) adding a two symbol period delayed signal with respect to the received signal to an output signal of the step (a);
(c) subtracting a three symbol period delayed signal with respect to the received signal from an output signal of the step (b);
(d) multiplying a one-and-a-half symbol period delayed signal with respect to the received signal, and an output signal of the step (c); and
(e) detecting symbol timing synchronization from an output signal of the step (d).

6. The detector of claim 1, wherein:
the detector generates a signal A by multiplying:
i) a) a half symbol period delayed signal with respect to the received signal, and
b) a signal obtained by subtracting a one symbol period delayed signal with respect to the received signal, from the received signal; and
generates a signal B by multiplying:
ii) a) a quarter symbol period delayed signal with respect to the received signal, and
b) a signal obtained by subtracting a one-and-a-quarter symbol period delayed signal with respect to the received signal from said a quarter symbol period delayed signal with respect to the received signal, and
generates a signal by adding:
iii) the signal A and the signal B, and
the detector outputs the generated signal as a signal for determining symbol timing synchronization.

7. The detector of claim 6, comprising:
at least one delay line delaying the received signal by a quarter symbol period; and
an adder, a subtracter, and a multiplier.

8. The detector of claim 7, comprising:
a first delay line delaying the received signal by a quarter symbol period,
a second delay line delaying an output of the first delay line by a quarter symbol period,
a third delay line delaying an output of the second delay line by a quarter symbol period,
a fourth delay line delaying an output of the third delay line by a quarter symbol period, and
a fifth delay line delaying an output of the fourth delay line by a quarter symbol period;
a first subtracter subtracting the output of the fourth delay line from the received signal;
a first multiplier multiplying the output of the second delay line and an output of the first subtracter;
a second subtracter subtracting an output of the fifth delay line from the output of the first delay line;
a second multiplier multiplying the output of the first delay line and an output of the second subtracter; and
an adder adding an output of the second multiplier to an output of the first multiplier.

9. A method for detecting symbol timing synchronization of a received signal in a communication device, the method comprising the steps of:
(a) subtracting a one symbol period delayed signal with respect to the received signal from the received signal;
(b) multiplying a half symbol period delayed signal with respect to the received signal, and an output signal of the step (a);
(c) subtracting a one-and-a-quarter symbol period delayed signal with respect to the received signal, from a quarter symbol period delayed signal with respect to the received signal;
(d) multiplying said a quarter symbol period delayed signal with respect to the received signal, and an output signal of the step (c);
(e) adding an output signal of the step (d) to an output signal of the step (b); and
(f) detecting symbol timing synchronization from an output signal of the step (e).

10. The detector of claim 1, generating a signal by multiplying:
i) the received signal, and
ii) the signal obtained by Hilbert transforming the received signal, or a signal obtained by differentiating the received signal,
wherein the detector outputs the generated signal as a signal for determining symbol timing synchronization.

11. The detector of claim 10, comprising:
a Hilbert transformer Hilbert transforming the received signal; and
a multiplier multiplying an output of the Hilbert transformer and the received signal.

12. The detector of claim 10, comprising:
a differentiator differentiating the received signal; and
a multiplier multiplying an output of the differentiator and the received signal.

13. A method for detecting symbol timing synchronization of a received signal in a communication device, comprising the steps of:
(a) Hilbert transforming the received signal or differentiating the same;
(b) multiplying an output signal of the step (a) and the received signal; and
(c) detecting symbol timing synchronization from an output signal of the step (b).

14. The detector of claims of claim 1 wherein the communication device is a communication system using any one of a pulse amplitude modulation (PAM) method, a quadrature amplitude modulation (QAM) method, an orthogonal frequency division multiplexing (OFDM) modulation method, a phase shift keying (PSK) method or a frequency shift keying (FSK) method.

15. The detector of claim 14, wherein a signal transmitted/received from the communication system is sampled at discrete time intervals, and a signal value is an analog value.

16. The method of claim 13, wherein the communication device is a communication system using any one of a pulse amplitude modulation (PAM) method, a quadrature amplitude modulation (QAM) method, an orthogonal frequency division multiplexing (OFDM) modulation method, a phase shift keying (PSK) method or a frequency shift keying (FSK) method.

17. The method of claim 16, wherein a signal transmitted/received from the communication system is sampled at discrete time intervals, and a signal value is an analog value.

18. A method for increasing a signal gain for detecting symbol timing synchronization of a received signal in a communication device, the method comprising the steps of:
determining an S-curve value of Expression 7 below from Expressions 8 to 11 according to delay time Δ;
selecting a plurality of delay times making the S-curve value determined in the previous step be the same trigonometric finction of the same sign; and
generating an output signal for detecting symbol timing synchronization by multiplying i) the received signal or a signal delayed by any one of the selected delay times, and ii) any one of a signal obtained by adding to or subtracting from the received signal a signal delayed by any one of the selected delay times with respect to the received signal, a signal obtained by Hilbert transforming the received signal, and a signal obtained by differentiating the received signal,
wherein the Expressions comprise:
$$\begin{matrix}S ( ∓ Δ T ) = {C}_{0} ( Δ ) + [ \frac{2}{{T}^{2}} {\int }_{- 0.5}^{0.5} H ( \frac{y + 0.5}{T} ) H ( \frac{- y + 0.5}{T} ) cos ( 2 πΔ y ) d y ] cos ( \frac{2 π t}{T} ∓ πΔ ) = {C}_{0} ( Δ ) + {C}_{1} ( Δ ) cos ( \frac{2 π t}{T} ∓ πΔ ) & [ Expression 7 ] \\ Δ = 0 , \pm 1 , \pm 2 , … S ( ∓ Δ T ) = {C}_{0} ( Δ ) + {C}_{1} ( Δ ) {( - 1 )}^{\vert Δ \vert} cos ( \frac{2 π t}{T} ) , & [ Expression 8 ] \\ Δ = \pm \frac{1}{2} , \pm \frac{3}{2} , \pm \frac{5}{2} , … S ( ∓ Δ T ) = {C}_{0} ( Δ ) + {C}_{1} ( Δ ) \text{sgn} ( Δ ) {( - 1 )}^{\vert Δ \vert - \frac{1}{2}} sin ( \frac{2 π t}{T} ) , & [ Expression 9 ] \\ \vert Δ \vert = ɛ \leq \frac{1}{2} S ( ∓ Δ T ) = {C}_{0} ( Δ ) + {C}_{1} ( Δ ) cos ( \frac{2 π t}{T} ∓ ɛπ ) 0 \leq ɛ \leq \frac{1}{2} , \\ and & [ Expression 10 ] \\ \frac{1}{2} \leq \vert Δ \vert \leq 1 S ( ∓ Δ T ) = {C}_{0} ( Δ ) + {C}_{1} ( Δ ) sgn ( Δ ) sin ( \frac{2 π t}{T} ∓ ɛπ ) 0 \leq ɛ \leq \frac{1}{2} . & [ Expression 11 ]\end{matrix}$$

19. A detector for detecting symbol timing synchronization of a received signal in a communication device, the detector generating signals, each of which is produced by multiplying:
a first signal which is the received signal or which is delayed by a first symbol delay with respect to the received signal, and,
a second signal which is delayed by a second symbol delay with respect to the received signal,
wherein the detector outputs a linear combination of the generated signals as a signal for determining symbol timing synchronization.

20. The detector of claim 19, wherein a timing detection wave(S-curve) is computed according to a correlation between the first signal and the second signal,
and the first symbol delay and the second symbol delay are determined in order that the computed timing detection wave may become a trigonometric function of the same type and same sign.

21. The detector of claim 20, wherein the timing detection wave S(+AT) is represented as
$$S ( ∓ Δ T ) = {C}_{0} ( Δ ) + [ \frac{2}{{T}^{2}} {\int }_{- 0.5}^{0.5} H ( \frac{y + 0.5}{T} ) H ( \frac{- y + 0.5}{T} ) cos ( 2 πΔ y ) d y ] cos ( \frac{2 π t}{T} ∓ πΔ ) = {C}_{0} ( Δ ) + {C}_{1} ( Δ ) cos ( \frac{2 π t}{T} ∓ πΔ ) \qquad [ Expression 7 ]$$
and according to a time delay Δ, the timing detection wave is computed by any one of the expressions:
$$\begin{matrix}Δ = 0 , \pm 1 , \pm 2 , … S ( ∓ Δ T ) = {C}_{0} ( Δ ) + {C}_{1} ( Δ ) {( - 1 )}^{\vert Δ \vert} cos ( \frac{2 π t}{T} ) , & [ Expression 8 ] \\ Δ = \pm \frac{1}{2} , \pm \frac{3}{2} , \pm \frac{5}{2} , … S ( ∓ Δ T ) = {C}_{0} ( Δ ) + {C}_{1} ( Δ ) \text{sgn} ( Δ ) {( - 1 )}^{\vert Δ \vert - \frac{1}{2}} sin ( \frac{2 π t}{T} ) , & [ Expression 9 ] \\ \vert Δ \vert = ɛ \leq \frac{1}{2} \\ S ( ∓ Δ T ) = {C}_{0} ( Δ ) + {C}_{1} ( Δ ) cos ( \frac{2 π t}{T} ∓ ɛπ ) 0 \leq ɛ \leq \frac{1}{2} , \\ and & [ Expression 10 ] \\ \frac{1}{2} \leq \vert Δ \vert \leq 1 \\ S ( ∓ Δ T ) = {C}_{0} ( Δ ) + {C}_{1} ( Δ ) \text{sgn} ( Δ ) sin ( \frac{2 π t}{T} ∓ ɛπ ) \\ 0 \leq ɛ \leq \frac{1}{2} . & [ Expression 11 ]\end{matrix}$$

22. A detector for detecting symbol timing synchronization of a received signal in a communication device, the detector generating signals, each of which is produced by multiplying:
a received signal and,
a time domain finction output of the received signal,
wherein the detector outputs a linear combination of the generated signals as a signal for determining symbol timing synchronization.

23. The detector of claim 22, wherein the time domain function includes any one of a delay function, a differential operation, and a Hilbert transform.

24. The detector of claim 22, wherein the time domain finction includes a square function.

25. A device for recovering a symbol timing comprising,
a symbol timing synchronization detector which outputs a signal for determining symbol timing synchronization, and,
a recovering means which recovers a symbol timing based on the output signal for determining the symbol timing synchronization,
wherein the detector outputs a linear combination of the signals as a signal for determining symbol timing synchronization, the signals obtained by multiplying a received signal and a time domain function output of the received signal.
